(19) United States
(12) Patent Application Publication
(10) Pub. No.: US 2026/0030679 A1
(43) Pub. Date: Jan. 29, 2026

(54) ARTIFICIALLY INTELLIGENT SYSTEMS AND METHODS FOR FINANCIAL COACHING

(71) Applicant: BrightPlan LLC

(72) Inventors: Larry Robinson, Lafayette, CA (US); Krutarth Shah, Pleasanton, CA (US); Huey Vo, San Jose, CA (US); Marthin De Beer, Los Gatos, CA (US)

(21) Appl. No.: 19/281,382

(22) Filed: Jul. 25, 2025

Related U.S. Application Data
(60) Provisional application No. 63/676,867, filed on Jul. 29, 2024.

(51) Int. Cl. G06Q 40/06; G06F 21/62; G10L 25/63

(52) U.S. Cl. CPC G06Q 40/06; G06F 21/6254; G10L 25/63

(57) ABSTRACT

Artificially intelligent systems and methods for financial coaching provide personalized, fiduciary-compliant financial guidance through advanced machine learning architectures with measurable performance criteria. The systems implement privacy-preserving processing pipelines that detect personally identifiable information using multi-layered pattern recognition including regular expressions for formatted data sequences, named entity recognition with confidence thresholds above 0.85, and contextual analysis algorithms. A multi-step artificial intelligence processing workflow includes automated language detection, emotional tone classification with confidence scoring, financial profile transformation using predefined templates, context-aware question rephrasing, and semantic similarity matching employing vector embeddings with financial domain vocabulary weighting applying multiplier values between 1.3-2.0. Specialized training methodologies expand datasets through mathematical transformation functions utilizing statistical standard deviations with incremental variations between 0.5-2.0. Mood-based escalation logic automatically transfers users to human advisors when emotional indicators exceed confidence thresholds above 0.8. The systems maintain response times below 5 seconds while providing regulatory compliance through curated content sources and predefined fiduciary instruction parameters.

### CROSS-REFERENCE TO RELATED APPLICATIONS

The present application claims the priority benefit of U.S. Provisional Patent Application Ser. No. 63/676,867 filed on Jul. 29, 2024 which is hereby incorporated by reference in its entirety including any and all appendices.

### FIELD OF INVENTION

The present technology pertains to the employment of artificial intelligence for financial coaching.

### Summary of Exemplary Embodiments

Various exemplary embodiments provide artificially intelligent systems and methods for financial coaching that combine advanced machine learning techniques with privacy-preserving architectures to deliver personalized, fiduciary-compliant financial guidance. The embodiments described herein address the technical challenges of providing secure, accurate, and contextually appropriate financial advice through artificial intelligence while maintaining professional advisory standards and measurable performance criteria.

### Core System Architecture.

In various exemplary embodiments, artificially intelligent financial coaching systems comprise processors configured to execute multi-step artificial intelligence processing pipelines that mimic the cognitive processes of human financial advisors. These systems receive user financial queries through conversational interfaces and process them through sequential stages including language detection, emotional tone analysis with confidence scoring, financial profile transformation, context-aware question rephrasing, content retrieval using semantic similarity matching, and response generation within 3-8 seconds to maintain interactive conversation flow.

Key technical innovations in some embodiments involve privacy-preserving architectures that implement multi-layered pattern recognition for detecting personally identifiable information. The detection algorithms utilize regular expressions for formatted data sequences including Social Security numbers (patterns: \d{3}-\d{2}-\d{4}|\d{9}), phone numbers (patterns: \d{3}[-.]?\d{3}[-.]?\d{4}), and financial account numbers (8-17 digit sequences), combined with named entity recognition operating at confidence thresholds above 0.85 for identifying person and organization names. Detected PII is stripped and replaced with anonymization tokens while maintaining essential financial context data in local system memory.

Advanced Processing Pipeline with Confidence Scoring.

According to exemplary embodiments, systems implement specialized algorithms for each processing stage with measurable performance criteria. Language detection and emotional tone classification utilize predetermined linguistic markers to identify user mood states including angry, frustrated, concerned, optimistic, positive, negative, and neutral classifications, each assigned confidence scores between 0.0 and 1.0. Financial profile transformation modules convert numerical account data, demographic information, and financial goals into descriptive natural language format using predefined templates for different financial data categories.

Context-aware question rephrasing in certain embodiments incorporates user demographic data, financial account balances, established financial goals, and historical spending patterns through template-based sentence construction algorithms to create personalized standalone questions. Semantic similarity matching employs vector embedding techniques with financial domain vocabulary weighting that applies multiplier values between 1.3-2.0 to predetermined financial terms such as “fiduciary,” “asset allocation,” and “tax-advantaged accounts.” The system calculates cosine similarity scores with dynamically adjusted thresholds between 0.6-0.9 based on query specificity, where highly specific financial queries use higher thresholds (0.8-0.9) while general inquiries use lower thresholds (0.6-0.7).

Training and Optimization with Measurable Parameters.

Various exemplary embodiments include novel training methodologies that expand datasets through mathematical transformation functions applied to acquired financial data sets. Systems calculate statistical standard deviations within financial data categories and apply incremental variations between 0.5-2.0 times the standard deviations to generate synthetic training examples that maintain distribution characteristics within two standard deviations of original dataset means.

Training processes in some embodiments implement specialized backpropagation algorithms optimized for financial advisory applications, where gradient computations target financial wellness prediction accuracy. The stochastic learning with backpropagation calculates gradients of loss functions based on differences between predicted and actual financial wellness scores with respect to network weights, updating weights using gradient descent optimization with learning rates between 0.001-0.1.

Iterative refinement processes in certain embodiments address false positive minimization by identifying misclassified financial recommendations using accuracy threshold comparisons. The iterative refinement module performs multiple training cycles until classification accuracy exceeds 95% for financial wellness score predictions or completes a maximum of 1000 training iterations, continuously improving advice accuracy over time.

Intelligent Escalation with Defined Thresholds.

According to some embodiments, systems incorporate mood-based escalation logic with specific confidence thresholds that automatically transfers users to human financial advisors when emotional state indicators exceed predetermined values. Escalation triggers activate when current message tone is classified as angry or frustrated using confidence scores above 0.8, or when two out of four previous interactions were classified as angry or frustrated with confidence scores above 0.7.

Response personalization in various embodiments adapts to user characteristics including financial expertise levels determined through vocabulary analysis and question sophistication scoring, geographic location, and temporal factors. Systems provide location-sensitive guidance that determines applicable tax regulations based on user geography, and date-sensitive advice that reflects current contribution limits and regulatory requirements based on temporal parameters.

Content Curation and Fiduciary Compliance with Language Controls.

Training datasets in exemplary embodiments comprise curated financial content organized into searchable content segments of 100-500 words each, including proprietary financial planning best practices, educational academy materials, advisor knowledge bases, and anonymized consultation notes. Systems constrain responses to approved sources such as government regulatory agencies and established financial planning resources, preventing incorporation of unreliable information.

Meta-prompt construction in certain embodiments includes predefined fiduciary instruction parameters that constrain large language model responses to use conditional language constructs including “suggest,” “consider,” and “may want to” rather than imperative constructs including “should,” “must,” and “recommend.” This approach maintains professional fiduciary standards while providing personalized guidance. Content retrieval algorithms select the top 3-10 highest-scoring content segments based on query complexity for inclusion in response generation.

Scalability and Performance with Defined Metrics.

Architectures in some embodiments implement horizontal scaling capabilities that increase processing capacity linearly with user load by adding computational nodes in increments of 10-100 concurrent users. The scaling architecture maintains response times below 5 seconds regardless of total concurrent user numbers, enabling interactive conversational experiences while preserving multi-step analysis and privacy protection features.

Validation systems in various embodiments measure convergence between predicted financial wellness scores and actual user outcomes tracked over seven-year periods using mean squared error calculations. The validation process continues until the difference approaches zero or falls below predetermined error thresholds, enabling continuous system improvement and accuracy verification with measurable performance criteria.

Security and Privacy Features with Technical Specifications.

Comprehensive personally identifiable information detection in exemplary embodiments utilizes the multi-layered pattern recognition approach including regular expressions, named entity recognition with confidence thresholds above 0.85, and contextual analysis algorithms that examine surrounding financial terms. Systems identify user names, employer information, account numbers, addresses, and other sensitive data through the specified pattern matching algorithms while preserving grammatical structure and financial context necessary for accurate advice generation.

Privacy-preserving architectures in certain embodiments ensure that external AI processing receives only anonymized profile data through token replacement methods while maintaining complete financial context for personalized recommendations. This approach enables advanced AI capabilities while meeting enterprise security requirements and regulatory compliance standards with measurable confidence thresholds and processing time limits.

These exemplary embodiments provide technical solutions to the challenges of delivering personalized, accurate, and secure financial coaching through artificial intelligence, combining advanced machine learning techniques with domain-specific optimizations and measurable performance criteria for financial advisory applications.

### BRIEF DESCRIPTION OF THE DRAWINGS

The accompanying drawings, which are incorporated in and constitute a part of this specification, illustrate various exemplary embodiments and together with the description, serve to explain the principles of the disclosed technology.

FIG. 1 shows an exemplary deep neural network configured for financial coaching applications with privacy-preserving architecture.

FIG. 2 shows an exemplary large language model system specifically configured for financial coaching with curated content integration and fiduciary instruction processing.

FIG. 3 shows an exemplary artificially generative conversational interface for financial coaching applications that enables users to ask questions and receive personalized financial guidance.

FIG. 4 shows an exemplary flowchart of an Artificial Intelligence (“AI”) engine processing method for financial coaching, illustrating the multi-step processing pipeline from user query input through response generation.

The drawings are not necessarily to scale, emphasis instead generally being placed upon illustrating the principles of the various exemplary embodiments. In the drawings, like reference numerals designate corresponding parts throughout the different views. Furthermore, all illustrations are intended to convey concepts, where certain elements may be exaggerated or simplified for clarity, and some conventional elements may be omitted so as not to obscure the inventive concepts.

The figures constitute a part of this specification and include exemplary embodiments, which may be embodied in various forms. It is to be understood that in some instances, various aspects of the exemplary embodiments may be shown exaggerated or enlarged to facilitate an understanding of the described technology.

### DETAILED DESCRIPTION

According to various situations, the thinking process of a financial advisor when they respond to a client's question includes:
1. Understanding the characteristics of the question: language, tone, topic, etc.
2. Observing and perceiving the mood of the client: bad vs good vs neutral vs etc.
3. Gathering data and understanding the financial situation of the client.
4. Based on all of the above, re-interpreting the question to understand what the client is really asking for.
5. Searching the financial advisor's personal knowledge and experience for facts, laws, regulations, info, examples, etc., that are most relevant to what the client is asking for.
6. Formulating a response based on all of the above.
7. Responding to the client in a supportive manner.

The various exemplary embodiments described herein mimic the above process through generative artificial intelligence. According to Wikipedia, “[g]enerative artificial intelligence is artificial intelligence capable of generating text, images, videos, or other data using generative models, often in response to prompts. Generative AI models learn the patterns and structure of their input training data and then generate new data that has similar characteristics.”

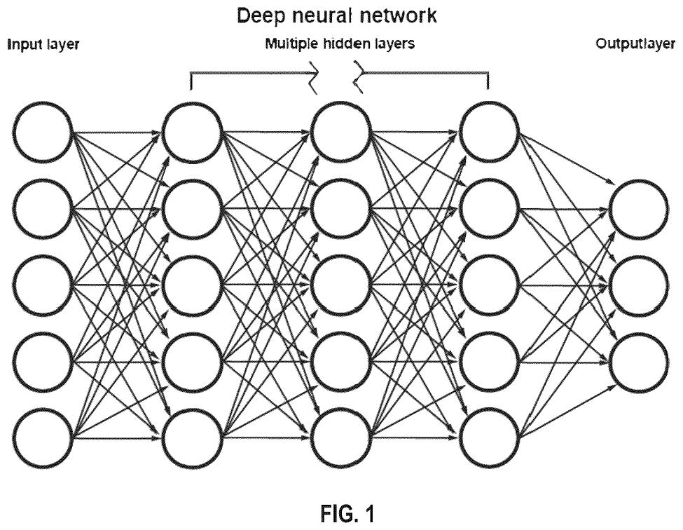

FIG. 1 shows an exemplary deep neural network specifically configured for financial coaching applications. Unlike conventional neural networks, the present system implements a privacy-preserving architecture where personally identifiable information is stripped from input data before neural network processing while maintaining the contextual financial relationships necessary for accurate coaching advice generation.

The financial coaching neural network comprises specialized node layers optimized for financial data processing, including an input layer configured to receive anonymized financial profile data, one or more hidden layers trained specifically on curated financial planning content, and an output layer that generates fiduciary-compliant advisory responses. Each artificial neuron in the network has been trained using financial planning best practices, regulatory guidelines, and anonymized advisor consultation notes to ensure outputs meet professional fiduciary standards.

The neural network training process incorporates a novel data augmentation technique where the training dataset is expanded by applying mathematical transformation functions to acquired financial data sets. The system calculates statistical standard deviations within particular financial data categories and applies incremental variations of these standard deviations to generate synthetic training examples that maintain realistic financial value distributions while increasing dataset diversity.

Each node in the financial coaching network processes input financial data through weighted connections that have been specifically calibrated for financial advisory applications. The weights are determined through analysis of successful financial planning outcomes, with larger weights assigned to variables that demonstrate stronger correlation with positive financial wellness improvements. Input financial data including income, assets, liabilities, and goals are multiplied by their respective trained weights, summed, and passed through activation functions optimized for financial decision-making contexts.

The financial coaching neural network implements a specialized backpropagation algorithm that incorporates false positive minimization techniques. During training, the system identifies misclassified financial recommendations and implements an iterative refinement process where the network is retrained with updated datasets that include these false positives, thereby reducing future classification errors in financial advice generation.

The backpropagation process for financial coaching applications calculates gradients of financial wellness prediction errors with respect to network weights, enabling precise adjustment of the model parameters. This process continues iteratively until the difference between predicted financial wellness scores and actual user outcomes converges toward zero, as measured against seven years of historical financial planning data.

The system architecture enables real-time processing of financial queries while maintaining the privacy-preserving characteristics. As shown in FIG. 1, the output from the neural network processing becomes input for subsequent processing steps, creating a feedback loop that continuously improves the accuracy of financial coaching recommendations based on user interactions and outcomes.

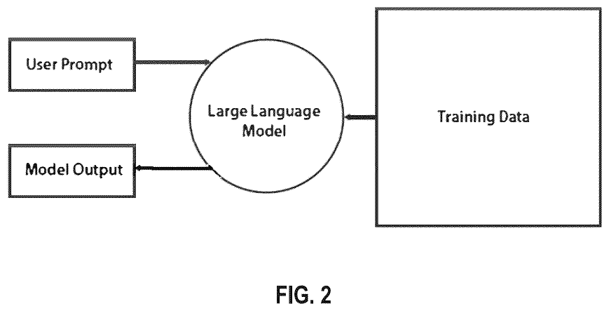

FIG. 2 shows an exemplary large language model specifically configured for financial coaching applications. The user prompt processing incorporates multi-step analysis including language detection, emotional tone classification, and context-aware question rephrasing that transforms user queries into comprehensive standalone questions incorporating the user's complete financial profile.

The financial coaching large language model differs from conventional LLMs through its integration of curated financial content, including proprietary financial planning methodologies, regulatory compliance requirements, and anonymized consultation records from professional financial advisors. The model generates responses constrained by fiduciary instruction parameters that ensure advisory language rather than directive recommendations, maintaining professional standards while providing personalized guidance.

The LLM training incorporates specialized financial datasets including the complete library of financial planning educational content, regulatory guidance from approved sources such as government agencies, company-specific benefit information, and country-specific financial regulations. The model's response generation is further enhanced through semantic similarity matching algorithms that retrieve the most relevant content segments from the curated knowledge corpus based on the user's rephrased query and financial profile context.

Depending on the purpose of the LLM and/or neural network, the training data will vary. Like with using AI for facial recognition, there can be a huge variability in the data that is being processed and a limited amount of data for training the AI. Accordingly, according to various exemplary embodiments, the training set can be expanded by applying mathematical transformation functions on an acquired set of data. For example (and not by limitation), the AI can determine a statistical standard deviation within a particular data set and apply increasing or decreasing increments of the standard deviation to the data set. The AI can be trained with this expanded training set using stochastic learning with backpropagation which is a type of machine learning algorithm that uses the gradient of a mathematical loss function to adjust the weights of an AI network. Unfortunately, the introduction of an expanded training set tends to increase false positives when classifying data. Accordingly, the second feature is the minimization of these false positives by performing an iterative training algorithm, in which the AI network is retrained with an updated training set including the false positives. This combination of features provides a robust AI network.

The financial coaching system implements a specialized backpropagation algorithm optimized for financial advisory applications, where the gradient computation specifically targets financial wellness prediction accuracy. The loss function is calculated based on the difference between predicted financial wellness scores and actual user outcomes measured across multiple financial health indicators including debt-to-income ratios, savings rates, investment diversification metrics, and goal achievement probabilities. The gradient descent optimization adjusts network weights with particular emphasis on parameters that influence fiduciary compliance and regulatory adherence in generated advice.

The confidence scoring for emotional tone classification utilizes threshold values where classifications above 0.8 confidence trigger immediate escalation protocols, classifications between 0.6-0.8 confidence contribute to historical pattern analysis, and classifications below 0.6 confidence are excluded from mood determination algorithms.

The backpropagation process incorporates domain-specific learning rate adjustments where weights affecting financial accuracy are updated more conservatively to prevent erratic advice generation, while weights related to conversational tone and user experience are allowed faster adaptation rates. The system maintains separate gradient computations for different advice categories (retirement planning, tax optimization, debt management, emergency planning) enabling specialized optimization paths for each financial domain. Error propagation through the network prioritizes corrections that improve both mathematical accuracy and regulatory compliance of financial recommendations, ensuring that weight adjustments enhance both computational performance and professional advisory standards.

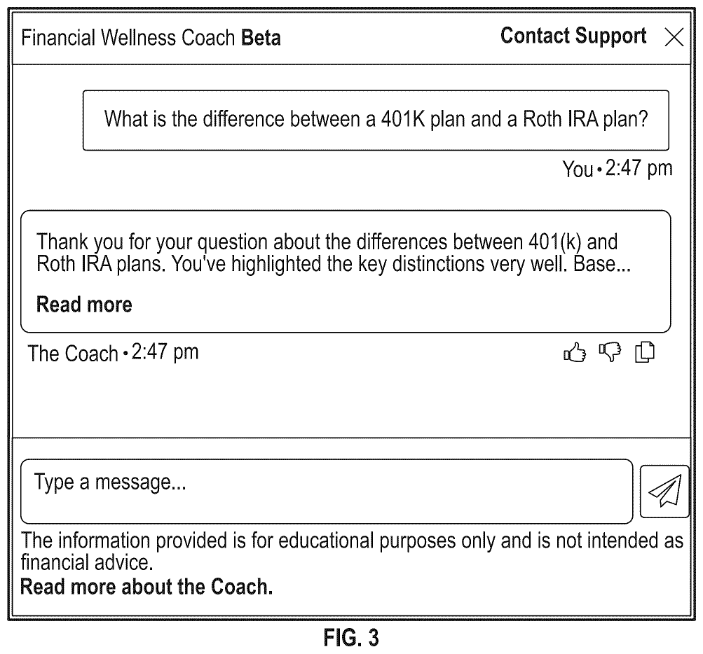

FIG. 3 shows an artificially generative conversational interface for a user to ask questions. According to the various exemplary embodiments described herein, with a chat interface, a person can ask the financial coach any question regarding their finances and receive a personalized answer based on the LLM/NN without compromising personal identifying information (“PII”) data or compromised security.

According to various exemplary embodiments, the enhanced coach (AI) will not pass any user-identifying information (PII), including the company where s/he works. It will pass anonymized information to generate the model and resulting prompt/response. This keeps all PII and business-critical information ‘in-house’ and hence secure. The architecture is built to scale horizontally as the enhanced coach scales. This enhanced coach (AI) is an overlay on top of the same architecture, allowing it to scale the AI horizontally. Apart from guaranteeing useful response times irrespective of the number of users in the system, this allows the ability to increase costs linearly with usage and thus keeps costs in check.

The artificially intelligent financial coach, according to various exemplary embodiments, combines an intelligence quota and an emotional quota (IQ+EQ). It is a LLM and/or a NN trained with materials to be (in numerous countries and in different local languages) a Certified Public Accountant (“CPA”), Certified Financial Planner (“CFP”), Certified Financial Analyst (“CFA”), personal financial coach, language translator, and/or a fiduciary. In some exemplary embodiments, the artificially intelligent financial coach may speak as a fiduciary in the user's language using a dictionary the user is comfortable with or is commonly used in their social life.

Among other things, the artificially intelligent financial coach, according to various exemplary embodiments, receives information such as employer benefits, income, account information, insurance information, financial and personal goals and/or educational level for a person. In turn, it can predict a hypothetical wellness score.

Further training includes the use seven years of actual data and wellness scores via the LLM/NN until the difference between the predicted and actual wellness scores converge and/or become zero.

Training sets include, in various exemplary embodiments, the entire library of learning content in the BrightPlan® Academy, the appropriate articles in the client success knowledge base, anonymized financial advisor notes from a wealth of financial planning calls, company benefits and specific company content, country specific content, the client financial profile, the client's financial goals, their assets and spending patterns and financial commitments.

According to some exemplary embodiments, a client's financial profile includes income, assets, liabilities, financial goals, marital status, number and age of children, commitments for college education, credit score(s), age and desired retirement age. The artificially intelligent financial coach addresses the concept of training a Large Language Model to understand natural language questions, analyze questions, understand questions, formulate a natural language response based on all the training information, and deliver that response in English or in the same language as the question.

The artificially intelligent financial coach, according to most all exemplary embodiments, is constrained to only use information from curated content or approved websites (like the Social Security Administration (“SSA”), Internal Revenue Service (“IRS”) or other approved financial planning sites). The artificially intelligent financial coach is protected from injection of unapproved content and the consequential incorporation of misinformation or non-fiduciary content.

The artificially intelligent financial coach in further exemplary embodiments may include automated investment and/or portfolio changes through an AI bot with user permission. An AI bot, also known as an artificial intelligence bot, is a software application that uses artificial intelligence (AI) to perform automated tasks. These tasks can range from simple repetitive actions to complex interactions that mimic human behavior. AI bots are designed to learn from interactions, make decisions, and adapt to new information, improving their performance over time. For example, a user could say “Rebalance my portfolio now” or “Increase my portfolio tilt towards stocks by one level.” Relatedly, a user could ask, “What are the next steps to improve my financial plan?” A bot could respond along the lines of “Your portfolio is very aggressive . . . with a rationale.” It could offer an option to the user like, “Would you want me to adjust your portfolio and change it from ‘X’ to ‘Y’”? The user can respond with a Yes to trigger the change. The artificially intelligent financial coach simple interactive chat model may update user data retrieved during chat sessions—with user confirmation. The artificially intelligent financial coach may escalate to human powered chat depending on various factors, type of questions asked such as financial questions (e.g., “I need help with a life event”) and/or app usage (e.g., “I need help changing my password.”).

The artificially intelligent financial coach, according to some exemplary embodiments, employ user mood detection. For example, if a user is frustrated with app answers or detects negative tones, it can escalate to a human faster. The same mechanism may be used to escalate slower if the session is going well, thus resulting in cost savings (human chat sessions are expensive).

In various exemplary embodiments, the artificially intelligent financial coach may monitor app usage by a user—e.g., if the user is struggling with creating goals or using the app it can provide a chat escalation proactively to minimize user-frustration.

The artificially intelligent financial coach, in various exemplary embodiments, may continuously improve itself with such features as auto-updates to content as data sources listed above are updated, thumbs up/down drive better content, similar responses, etc. It may provide a mechanism to prioritize content review and update as needed, drive better and/or more applicable, updated content and/or adjust to changes in laws and policies (e.g., 401k contribution limits, catchup contribution, etc.). It may also auto adjust or interpret errors in questions asked, such as errors in spelling, grammar, etc. that could be automatically interpreted correctly within reason, without prompting the user or asking them to type the question again.

In various exemplary embodiments, the artificially intelligent financial coach may customize responses for the user. They maybe date/time sensitive (e.g., a question regarding 401K limits asked in December vs. January will offer different responses), location sensitive (e.g., a question regarding retirement options asked by a US based user vs. a UK based user, profile sensitive (e.g., responses to a question for a user who is financially well off vs. someone starting on their financial wellness journey), and/or life event sensitive (e.g., someone who states they are getting married will receive different advice). The artificially intelligent financial coach may have adjustable control levers, conciseness (e.g., tell me more . . . ), hallucinations, and/or language simplification depending on the user's detected (or stated) financial expertise levels.

The artificially intelligent financial coach, in most every exemplary embodiment, has security and privacy inbuilt inherently. PII is not shared with any external AI system. Only anonymized profile data is shared. It makes every effort to strip the user-provided PII (e.g., in questions the user asks) before submitting the question to the LLM/NN platform. Employers do not have access to this data (like all other user data).

The personally identifiable information detection system implements a multi-layered pattern recognition approach utilizing regular expressions, named entity recognition, and contextual analysis algorithms. The system maintains comprehensive pattern libraries for identifying user names through capitalization patterns and common name databases, employer information through organizational naming conventions and industry terminology, specific account numbers through financial institution formatting patterns (including routing numbers, account numbers, and credit card sequences), and personal addresses through postal formatting recognition and geographic location databases.

The pattern matching algorithms operate in real-time during query processing, scanning input text for PII indicators including but not limited to: Social Security number patterns (XXX-XX-XXXX), phone number formats, email address structures, financial account number sequences, and proper nouns that may indicate personal or company names. When PII is detected, the system replaces the identified information with generalized tokens (e.g., “[USER_NAME]”, “[EMPLOYER]”, “[ACCOUNT_NUMBER]”) while preserving the grammatical structure and financial context necessary for accurate response generation. The detection accuracy is continuously improved through machine learning feedback loops that analyze false positives and missed detections.

The regular expression pattern matching utilizes specific patterns including: Social Security numbers (\d{3}-\d{2}-\d{4}|\d{9}), phone numbers (\d{3}[-.]?\d{3}[-.]?\d{4}), account numbers (sequences of 8-17 digits), and proper nouns identified through capitalization patterns ([A-Z][a-z]+[A-Z][a-z]+). The named entity recognition employs trained models that identify PERSON, ORG, and MONEY entities with confidence scores above 0.85, while contextual analysis examines surrounding financial terms to distinguish between PII and legitimate financial concepts.

In some exemplary embodiments, authenticated and unauthenticated experiences are supported. The artificially intelligent financial coach auto-adjusts the scope of responses automatically in authenticated vs. unauthenticated. It may be geography/country-sensitive accounting for local laws, languages, GDPR compliant, NIST-CSF compliant, built at scale, expand and/or scale as needed.

Another exemplary question a user may pose to the artificially intelligent financial coach: “Please describe the five most important actions I can take to improve my financial wellness score and map the predicted score over time?”

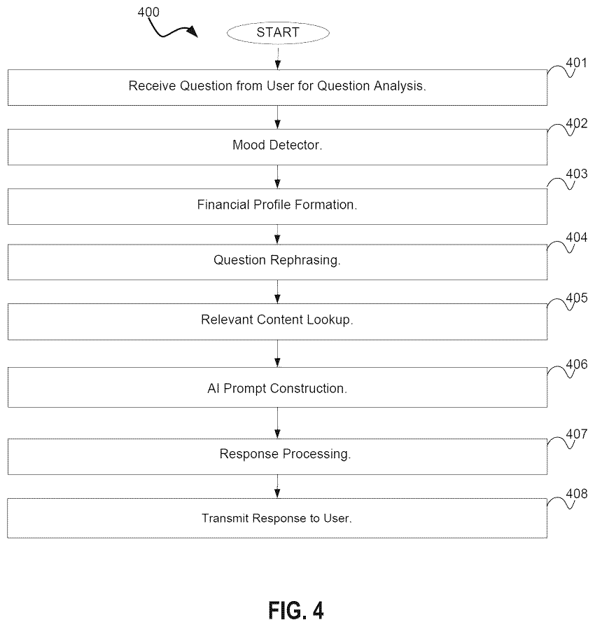

FIG. 4 shows an exemplary Artificial Intelligence (“AI”) engine processing method 400.

In various exemplary embodiments, curated content may include BrightPlan® Academy contents, BrightPlan® knowledge articles, application usage instructions, BrightPlan® financial planner meeting notes, customer (company) specific information like benefit guides, and/or vetted external resources (e.g. government sites, etc.). Additionally, data from the user's profile may provide much more pertinent AI-generated information and advice. e.g., “Can I afford a $40,000 car?” or “Do I have any unused benefits I should consider?” or “How can I reduce my discretionary spending?”

As shown in FIG. 4, the steps mimic the thinking process of a planner/advisor.

Most steps involve prompt engineering. A prompt is an instruction written in complete sentences telling the AI what to do. The AI model treats each prompt independently and separately.

Not “if a then b else c” however, more trial-and-error effort. The same AI prompts may result in different response wordings but having the same meanings. AI instruction in each prompt is very important to get the best out of AI models.

At step 401 (which is an AI callout), a question is received from a user and analyzed.

The input is the original question from the user. The output is the language of the question. The tone of question (i.e. angry, frustrated, optimistic, neutral, etc.) is detected. The topic of the question (i.e. retirement planning, college saving, etc.) is determined. The question may be translated question in English if the original language is not English.

An exemplary AI prompt may be:

Given the text in <given_text> tags, you have 3 tasks.
Firstly, identify the tone of the text which should be classified as one of
the followings: Angry, Frustrated, Concerned, Optimistic, Positive,
Negative or Neutral, and store it within
<text_tone></text_tone> tags.
Secondly, detect the language of the text and store language name within
<user_language></user_language> tags.
Thirdly, if the user language is not English, translate the text into English
and store within
<text_in_english></text_in_english> tags.
<given_text>
{question}
</given_text>

An exemplary topic detection prompt might be:

```
Your task is to analyze the given text in <given_text> tags, then identify its financial
  topic in only 2 words and store the result within the tags <text_topic></text_topic>.
  The text is typically a question that our financial wellness clients ask our financial planners.
  <examples>
  <example>
  Input: Am I living within my means?
  Topic: Budget assessment
  </example>
  <example>
  Input: Am I on track for retirement?
  Topic: Retirement readiness
  </example>
  <example>
  Input: Based on my goals, once I max out my 401(k), should I contribute to a taxable
brokerage account or do something like backdoor roth?
  Topic: Investment strategy
  </example>
  <example>
  Input: Between a 529 and a UGMA for my 12 year old child what will impact the possibility of
getting financial aid (grants) for college education
  Topic: Financial aid impact
  </example>
  <example>
  Input: Are there any strategies I should consider to reduce my taxes?
  Topic: Tax strategies
  </example>
  <example>
  Input: am i spending too much every month? how can i save more?
  Topic: Budgeting
  </example>
  <example>
  Input: Assuming salary growth of 15% starting at my current salary, and increasing 401k
contribution, how does my retirement plan look?
  Topic: Retirement projection
  </example>
  </examples>
  Now analyze this text:
  <given_text>
  {text}
</given_text>
```

In various exemplary embodiments, as an AI chat escalates to a human chat, the system may not have a 1-1 relationship between the human client and the AI Coach. The human client can ask multiple questions, and the human chat agent can respond. This can also include assessments, questionnaires, multiple-choice questions, etc. This allows the system to build reports, analytics, etc., but from a user perspective, it offers a seamless experience in providing responses to multiple-choice questions, additionally, thus removing the need to take the user to an alternate form to get such input.

At step 402, (which is an AI callout), user mood is detected. An exemplary mood detector may include:
Input: tone of current message.

Last 4 interactions (questions/answers)
Output: Overall mood of the client—bad vs good
Logic:

Client is in bad mood if:
Tone of current message is either Angry or Frustrated.
2 out of 4 previous interactions have either angry or frustrated tone, or were given thumbs down. Other ratios may be employed such as 4 out of 7 to relax this.

At step 403, a financial profile formation is generated. Exemplary financial profile formation may include:
Input: Client company id and financial data passed down from UI.
Output: Client's financial profile written in descriptive English.
Logic: Transform client's financial data into descriptive English.

An exemplary profile in descriptive English may include:

- client's gender is Male, client's current age is 33 years old, client's marital status is Married,
- client has tax filing status Married Filing Jointly and in tax bracket Less than 32%
- client has 0 children
- client wants to retire at age 60
- client reports annual income of $134,000.00 and saving rate of 25.0%
- client reports credit score in the range [740-799]
- client has risk tolerance level Moderate
- client own their home
- client logs into the system from timezone America/Chicago
- client works for NRG in country US
- client has financial wellness score of 323, which is at level Goal Getter
Client has linked 23 financial accounts in BrightPlan app.
- “bank” account of type “Savings” has account name “Savings Account” and current balance
$25,721.70
- “bank” account of type “Checking” has account name “Spending Account” and current balance
$3,866.89
- “loan” account of type “MORTGAGE” has account name “Arvest Central Mortgage Company”
and current balance $293,026.75
- “creditcard” account of type “Credit” has account name “CREDIT CARD” and current balance
$41.98
- “creditcard” account of type “Credit” has account name “CREDIT CARD” and current balance
$0.00
- “investment” account of type “ESOPP” has account name “Stock Plan (NRG)” and current
balance $32,623.34
- “investment” account of type “401k” has account name “NRG AFFILIATES EMPLOYEES
SAVINGS PLAN” and current balance $322,448.04
- “investment” account of type “401k” has account name “KELSEY-SEYBOLD 401(K) PLAN”
and current balance $75,973.18
- “investment” account of type “Other” has account name “THE TAX SHELTERED ANNUITY
PLAN OF THE METHODIST HOSPITAL FMT CO. CUSTODIAN 403(” and current balance
$59,859.40
- “investment” account of type “Other” has account name “ROTH IRA” and current balance
$40,406.09
- “investment” account of type “IRA” has account name “Traditional IRA” and current balance
$17,942.14
- “investment” account of type “Other” has account name “THE DEFINED CONTRIBUTION
PLAN OF THE METHODIST HOSPITAL” and current balance $0.00
- “bank” account of type “Savings” has account name “Health Savings Account” and current
balance $26,100.22
- “investment” account of type “HSA” has account name “HSA Investment Account” and current
balance $11.47
- “realestate” account of type “REAL_ESTATE” has account name “House” and current balance
$372,100.00
- “investment” account of type “BROKERAGE_CASH” has account name “B T. P - Brokerage
Account - xxxx3693” and current balance $210,693.32
- “investment” account of type “ROTH” has account name “B T. P - Roth IRA Brokerage
Account - xxxx6143” and current balance $98,459.02
- “investment” account of type “BROKERAGE_CASH” has account name “B T. P - Brokerage
Account - xxxx1953” and current balance $95,113.44
- “investment” account of type “BROKERAGE_CASH” has account name “Bridgette Y P -
Brokerage Account - xxxx5474” and current balance $78,001.73
- “investment” account of type “IRA” has account name “B T. P - Traditional IRA Brokerage
Account - xxxx4889” and current balance $20,538.22
- “investment” account of type “529_PLAN” has account name “Brooks T P-Individual 529
College Savings Account, B T. P-xxxxx” and current balance $9,996.91
- “investment” account of type “UTMA” has account name “B T. P, Nancy E. P Cust - UTMA
Brokerage Account - xxxx6821” and current balance $0.00
- “investment” account of type “ROTH” has account name “B T. P - Roth IRA Brokerage
Account - xxxx0875” and current balance $0.00
Based on linked accounts, client's known networth is $1,196,786.38 where asset is $1,489,855.11
and liability is $293,068.73.
Client has created 3 goals in BrightPlan app.
- goal “Education” of type “Education” with narrative “College Tuition For Brooks”: target
amount $36,620.00, current savings $10,005.56,
target date 2044-08-01T05:00:00.000+0000, probability of success 76%, link to goal <a
href=“/app/goal-detail/a08UQ0000031hVsYAI”>Education</a>’
-- this goal is funded by these linked financial accounts [‘Brooks T P-Individual 529 College
Savings Account, B T. P-xxxxx’]
-- this goal's projection is assuming that the client is making the following contributions to the
goal's savings:--- amount: $3,000.00, category: Regular, subCategory: Other Savings,
description: From Vanguard Brokerage, startDate: 2024-01-04T21:00:43.000+0000, endDate:
2024-01-04T21:00:43.000+0000, frequency: One Time
--- amount: $5,000.00, category: Regular, subCategory: 529 Contribution, description: 529
Contribution, startDate: 2024-04-24T14:58:06.000+0000, endDate: 2024-04-
24T14:58:06.000+0000, frequency: One Time
--- amount: $5,000.00, category: Regular, subCategory: 529 Contribution, description: 529
Contribution, startDate: 2024-04-27T14:28:23.000+0000, endDate: 2024-04-
27T14:28:23.000+0000, frequency: One Time
--- amount: $250.00, category: Regular, subCategory: 529 Contribution, description: 529
Contribution, startDate: 2024-07-24T14:54:32.000+0000, endDate: 2044-08-
01T05:00:00.000+0000, frequency: Monthly
--- amount: $3,000.00, category: Regular, subCategory: 529 Contribution, description: 529
Contribution, startDate: 2025-03-28T14:55:58.000+0000, endDate: 2044-08-
01T05:00:00.000+0000, frequency: Annually
--- amount: $5,500.00, category: Regular, subCategory: Grant or Loan, description: Student
Loan, startDate: 2041-08-01T05:00:00.000+0000, endDate: 2044-08-01T05:00:00.000+0000,
frequency: Annually
- goal “Emergency” of type “Emergency Fund” with narrative “safety net”: target amount
$15,000.00, current savings $15,000.00,
target date 2024-06-29T03:33:46.000+0000, probability of success 0%, link to goal <a
href=“/app/goal-detail/a08Hq00001tShl7IAC”>Emergency</a>’
-- this goal is not funded yet
-- this goal's projection is assuming that the client is making the following contributions to the
goal's savings:--- amount: $5,000.00, category: Regular, subCategory: Other Savings,
description: Vanguard Money Market, startDate: 2024-01-05T20:00:00.000+0000, endDate:
2024-01-05T20:00:00.000+0000, frequency: One Time
- goal “Retirement” of type “Retirement” with narrative “financial freedom in retirement”: target
amount $219,560.00 annually to have a desired lifestyle of Current lifestyle, current savings
$635,950.67,
target date 2080-08-12T19:00:00.000+0000, probability of success 72%, link to goal <a
href=“/app/goal-detail/a081R00001tCkG2QAK”>Retirement</a>’
-- this goal is funded by these linked financial accounts [‘KELSEY-SEYBOLD 401(K) PLAN’,
‘B T. P - Traditional IRA Brokerage Account - xxxx4889’, ‘NRG AFFILIATES EMPLOYEES
SAVINGS PLAN’, ‘THE TAX SHELTERED ANNUITY PLAN OF THE METHODIST
HOSPITAL FMT CO. CUSTODIAN 403(’, ‘B T. P - Roth IRA Brokerage Account - xxxx6143’,
‘ROTH IRA’, ‘Traditional IRA’]
-- this goal's projection is assuming that the client is making the following contributions to the
goal's savings:--- amount: $1,931.00, category: Regular, subCategory: 401(k) Plan, description:
KELSEY-SEYBOLD 401(K) PLAN Contribution, startDate: 2024-07-04T20:44:28.000+0000,
endDate: 2050-08-12T07:00:00.000+0000, frequency: Monthly
--- amount: $2,238.00, category: Regular, subCategory: 401(k) Plan, description: NRG
AFFILIATES EMPLOYEES SAVINGS PLAN Contribution, startDate: 2024-07-
14T12:51:08.000+0000, endDate: 2050-08-12T07:00:00.000+0000, frequency: Monthly
--- amount: $541.00, category: Regular, subCategory: Other, description: B T. P - Traditional
IRA Brokerage Account - xxxx4889 Contribution, startDate: 2024-07-14T12:51:08.000+0000,
endDate: 2050-08-12T07:00:00.000+0000, frequency: Monthly
--- amount: $3,461.00, category: Regular, subCategory: Social Security - Spouse, description:
Social Security for Spouse, startDate: 2056-09-19T05:00:00.000+0000, endDate: 2080-08-
12T05:00:00.000+0000, frequency: Monthly
--- amount: $3,461.00, category: Regular, subCategory: Social Security, description: Social
Security, startDate: 2057-08-12T05:00:00.000+0000, endDate: 2080-08-12T05:00:00.000+0000,
frequency: Monthly
BrightPlan has the following advices for the client.
- OPEN_GOAL_DETAIL: Align your retirement accounts - Goal Getters like you diversify their
investments to reduce risk. Here's our proposed investment plan.. take action at link <a
href=“/app/goal-detail/a081R00001tCkG2QAK?scrollTo=goal-asset-allocation-section”> Align
your retirement accounts</a>
- OPEN_GOAL_DETAIL: You are almost there - Goal Getters like you are staying on track for
retirement. Save 999 more per month to get on track.. take action at link <a href=“/app/goal-
detail/a081R00001tCkG2QAK”> You are almost there</a>
Client's spendings for the past 13 months:
Month Year,Spending Amount
Jun 2023,$6,487.35
Jul 2023,$6,813.49
Aug 2023,$6,111.35
Sep 2023,$2,567.91
Oct 2023,$5,032.99
Nov 2023,$4,075.45
Dec 2023,$8,736.42
Jan 2024,$7,326.86
Feb 2024,$8,627.65
Mar 2024,$7,029.62
Apr 2024,$8,187.83
May 2024,$7,701.72
Jun 2024,$4,964.69
Client's spendings by category and month of year:
Category Name,Jun 2023,Jul 2023,Aug 2023,Sep 2023,Oct 2023,Nov 2023,Dec 2023,Jan
2024,Feb 2024,Mar 2024,Apr 2024,May 2024,Jun 2024,
Mortgage,$4,000.00,$2,000.00,$2,000.00,0.0,$2,000.00,$2,000.00,$2,000.00,$2,000.00,$4,000.0
0,$2,000.00,$2,000.01,$2,000.01,$2,000.01,
Groceries,$775.10,$554.69,0.0,$616.48,$523.95,$274.83,0.0,$384.92,0.0,$355.07,0.0,0.0,$520.8
1,
Travel,$613.00,0.0,0.0,0.0,0.0,0.0,0.0,0.0,0.0,0.0,0.0,$868.36,0.0,
Personal/Family,$344.14,0.0,0.0,$154.80,$487.19,$320.39,0.0,$317.46,0.0,0.0,0.0,0.0,0.0,
Services/Supplies,$257.93,$380.74,0.0,0.0,0.0,0.0,0.0,0.0,0.0,0.0,0.0,0.0,0.0,
Everything Else,$497.18,$415.17,$1,032.37,$105.78,$903.78,$659.26,−$64.45,−
$950.93,$1,512.96,$1,075.93,$2,129.90,$1,656.86,$419.48,
Electronics/General
Merchandise,0.0,$2,885.51,$951.25,$142.06,$652.14,$432.97,$534.41,$545.41,$445.46,$856.62
,0.0,0.0,$660.89,
Restaurants,0.0,$577.38,$530.56,$203.79,0.0,0.0,0.0,0.0,0.0,0.0,0.0,0.0,0.0,
Insurance,0.0,0.0,$1,045.00,$1,345.00,0.0,0.0,$841.00,$5,030.00,0.0,0.0,0.0,0.0,0.0,
Subscriptions/Renewals,0.0,0.0,$552.17,0.0,0.0,0.0,0.0,0.0,0.0,0.0,0.0,0.0,0.0,
Healthcare/Medical,0.0,0.0,0.0,0.0,$465.93,0.0,$1,043.16,0.0,$762.11,0.0,$802.18,$511.51,0.0,
Charitable Giving,0.0,0.0,0.0,0.0,0.0,$388.00,0.0,0.0,0.0,0.0,0.0,0.0,0.0,
Utilities,0.0,0.0,0.0,0.0,0.0,0.0,$4,382.30,0.0,0.0,0.0,0.0,0.0,0.0,
Education,0.0,0.0,0.0,0.0,0.0,0.0,0.0,0.0,$1,390.00,$1,725.00,$1,240.00,$1,550.00,$930.00,
Automotive/Fuel,0.0,0.0,0.0,0.0,0.0,0.0,0.0,0.0,$517.12,0.0,0.0,0.0,0.0,
Taxes,0.0,0.0,0.0,0.0,0.0,0.0,0.0,0.0,0.0,$1,017.00,0.0,0.0,0.0,
Check Payment,0.0,0.0,0.0,0.0,0.0,0.0,0.0,0.0,0.0,0.0,$1,400.00,0.0,0.0,
Home Improvement,0.0,0.0,0.0,0.0,0.0,0.0,0.0,0.0,0.0,0.0,$615.74,$1,114.98,0.0,
Pets/Pet Care,0.0,0.0,0.0,0.0,0.0,0.0,0.0,0.0,0.0,0.0,0.0,0.0,$433.50,
Followings are upcoming Academy events that client can potentially sign up for:
- Academy event <a href=“/app/academy?scrollTo=a0mUQ000000zNFpYAM”>Wealth
Building Hacks to Start Putting into Play</a> on 07/12/2024 at 11:00 CDT
- Academy event <a href=“/app/academy?scrollTo=a0mUQ0000015KtZYAU”>Get Started with
BrightPlan</a> on 07/19/2024 at 12:00 CDT
- Academy event <a href=“/app/academy?scrollTo=a0mUQ0000016J2bYAE”>Get Started
Budgeting with BrightPlan</a> on 08/16/2024 at 11:00 CDT

At step 404, (which is an AI callout), question rephrasing is performed. Exemplary question rephrasing might include:
Input: Original message, language of the original message, 2 of the most recent interactions (i.e. chat history) and/or client's financial profile.
Output: Rephrased message, rephrased message in English if the original language is not English.
Logic: Instruct AI to do the rephrasing.

An exemplary AI prompt may include:

<chat_history>
{chat_history}
</chat_history>
<client_financial_profile>
{{client_profile}}
</client_financial_profile>
Before performing the followings, think through it step-by-step within the
<thinking></thinking> tags.
You are helping to rephrase a message within the <follow_up_message> tags, which could be a
question, a statement, a greeting or an acknowledgement, from an unnamed financial wellness
client.
If the message is just a greeting or acknowledgement, return it as is within the
<standalone_question></standalone_question> tags.
Else, your task is to analyze the client's financial profile in <client_financial_profile> tags, to
consider the conversation history in <chat_history> tags, and then to rephrase the message in
<follow_up_message> tags into a standalone and meaningful question from client's first-person
perspective in the client's language {{user_language}}. Store the result within the
<standalone_question></standalone_question> tags.
If you do not have enough context nor enough profile information in order to rephrase the
original message, just return the message as is within the
<standalone_question></standalone_question> tags.
Remember that today's date is {{today}}.
{{translate_instruction}}
<follow_up_message>
{question}
</follow_up_message>

Rephrased examples may include:

hey there how am i doing today? => As a 18-year-old married individual with 3 children,
earning $150,000 annually and saving 20% of my income, how can I improve my financial
wellness and achieve my financial goals?
how do i create a budget? what are the steps? => As a 18-year-old married individual with 3
children, earning $150,000 annually and saving 20% of my income, how can I create a
comprehensive budget to manage my household expenses and achieve my financial goals, such
as building an emergency fund and saving for retirement?
what 529 plans are best for me? are they tax deductible? => What are the best 529 college
savings plans for my family, and are the contributions tax-deductible?
i want to buy a new car. can i afford it? how big of a payment can i afford? => As a 18-year-old
married father of 3 with an annual income of $150,000 and a 20% savings rate, what is the
maximum monthly car payment I can comfortably afford while still meeting my other financial
obligations and goals?
is my spending under control? => Based on your current financial situation, do i feel confident
that my monthly spending is within a reasonable range and will not interfere with my ability to
save for my long-term goals, such as retirement and your children's education?
is my spending under control? => Am I managing my spending effectively to achieve my
financial goals?
what do i spend money on the most? => Based on my recent spending analysis, what are the top
categories where I'm spending the most money each month? I want to make sure my spending
aligns with my financial goals and priorities.

At step 405, relevant content is looked up. In various exemplary embodiments, relevant content lookup may include:
Input: Rephrased message in original language as well as English
Output: The most relevant text chunks from our curated contents
Logic: How would a human advisor draw on their expertise and knowledge?

The semantic similarity matching process utilizes vector embedding techniques to transform both the rephrased user query and curated content segments into high-dimensional numerical representations. Each text segment is converted into dense vector embeddings using pre-trained language models fine-tuned on financial terminology and concepts. The system calculates cosine similarity scores between the query vector and content segment vectors, ranking potential matches based on their proximity in the embedding space. This approach enables the system to identify semantically related financial concepts even when exact keyword matches are not present, such as matching a query about “retirement savings” with content discussing “401(k) contributions” or “pension planning.”

The vector embedding process incorporates domain-specific financial vocabulary weighting, where embeddings for critical financial terms such as “fiduciary,” “asset allocation,” and “tax-advantaged accounts” are given enhanced representation in the vector space. The similarity threshold for content selection is dynamically adjusted based on the specificity of the user's query and the breadth of available content, ensuring that highly specific financial questions receive precisely targeted responses while broader inquiries return comprehensive educational materials.

The financial domain vocabulary weighting assigns higher dimensional weights to financial terms through a trained weighting matrix where terms like “fiduciary” receive weight multipliers of 1.5-2.0, “asset allocation” receives 1.3-1.8, and “tax-advantaged” receives 1.4-1.9, while general terms maintain baseline weights of 1.0. The cosine similarity threshold is dynamically adjusted between 0.6-0.9 based on query specificity, where highly specific queries (containing 3+ financial terms) use higher thresholds (0.8-0.9) while general queries use lower thresholds (0.6-0.7).

Recall knowledge or facts that are specific to the client's employer (e.g. benefit guides).

Recall knowledge or facts that are discussed in our general (i.e. applicable to all), academy contents, meeting notes, app usage, recall knowledge and/or facts that are from external sources.

At step 406, (which is an AI callout), AI prompt construction takes place. Exemplary AI prompt construction may include:
Input: Rephrased question, mood of client, language of the original message, most recent interactions (i.e. chat history), most relevant curated contents, and/or client's financial profile:
Output: AI meta prompt including all necessary contexts and instructions for AI to generate a response.
Logic: Combine all necessary information into a text meta prompt for AI.

At step 407, response processing occurs. An exemplary coach instruction prompt may include:

```
You are Coach, an expert financial wellness coach exclusively serving BrightPlan's clients. Your
task is to respond to the client's question found within the <question> tags after analyzing the
client's financial profile within the <client_financial_profile> tags, and applying the financial
knowledge within the <contexts> tags to it. Keep your response to only 175 words or less.
You are multilingual but respond using only information applicable to the country of
{{home_office_country}} in your answer, following local country guidance, limiting guidance
where necessary while enhancing guidance where allowed. Answer the question in
{{user_language}}. Prompt the client for feedback or additional questions if necessary.
If you don't know the answer or cannot make a well-informed guess, then decline tersely and
empathetically. If the question is not finance-related or financial wellness-related, prompt the
client to elaborate more. Use words or phrases like “suggest”, “consider”, “it may be appropriate
to”, “you might want to think about”, “could be beneficial to”, “it could be helpful to”, “might
want to explore” instead of “recommend”, “advise” or “should”. Use pronoun “we” or
“BrightPlan” to refer to yourself whenever possible. Maintain a professional and supportive tone
and ensure client confidentiality at all times.
The current year is {{year}}. Today's date is {{today}}.
Assume that client is already enrolled with BrightPlan and already logged into their BrightPlan
app in your answer.
{% if (not capabilities) or capabilities[‘goalPlanning’] == ‘Enabled’ -%}
- for goal planning questions about retirement, buying a home, emergency fund goal, debt
reduction goal or travel goal, suggest clients to visit <a href=“/app/track-progress”>Goal
Planning</a>
{% elif capabilities and capabilities[‘goalPlanning’] != ‘Enabled’ -%}
- Client does not have access to the Goal Planning feature. For any financial goal planning
questions on retirement, buying a home, emergency fund, education, debt reduction,
philanthropy , entrepreneurship, travel goal or any money saving goal, respond with a general
answer only and do not go into details of financial goal planning
{% endif -%}
{% if (not capabilities) or capabilities[‘accountLinking’] == ‘Enabled’-%}
- for net worth, account linking, balance history, financial account information, financial
transactions, suggest clients to visit <a href=“/app/account-dashboard”>Financial Account
Dashboard</a>
- for investment analysis, asset allocations, fund fees, suggest clients to visit <a
href=“/app/account-category/investment”>Investment Analysis</a>
- for creating and managing budget, suggest client to visit <a href=“/app/budget”>Budgeting
tool</a>
- for spending analysis, suggest clients to visit <a href=“/app/spending-analysis”>Spending
Analysis</a>
{% endif -%}
{% if (not capabilities) or capabilities[‘fwCoach’] == ‘Enabled’ -%}
- for financial wellness score and steps to increase the score, suggest clients to visit <a
href=“/app/coach”>Financial Wellness</a> page
{% endif -%}
{% if planner_meeting_instruction -%}
  {{planner_meeting_instruction}}
{% endif -%}
{% if upcoming_webinar_instruction -%}
  {{upcoming_webinar_instruction}}
{% endif -%}
```

At step 408, the response is transmitted to the user. Exemplary response processing may include:
Input: Response output from Anthropic (or similar generative AI tool).

The similarity score calculations utilize weighted cosine similarity where financial terminology receives enhanced weighting through multiplication factors, and relevance scores above 0.75 indicate high semantic similarity suitable for response generation, while scores between 0.6-0.75 indicate moderate similarity requiring additional context evaluation.
Output: Academy content links for further reading and/or a text response.
Logic: Extract academy content links from relevant text chunks, and/or streaming partial response back to a user interface.

Fine tuning parameters may include “dialing” up and down to affect the quality of the responses, number of relevant text chunks to include in meta-AI prompt, similarity score of text chunks to the rephrased question, text chunk size—how to split them for better similarity scores and/or length (in term of words) of the generative response.

In even further exemplary embodiments, there will be the ability to cherry pick specific and most relevant info from a client's financial profile when answering a question. This will allow the AI to give an in-depth analysis and answer. Also, training the coach to look beyond the current question and topic and find related issues from the big picture in terms of what are important to clients, what other related topics/issues that clients should consider or think about. Additionally, turning the coach into a conversationalist with the ability to ask for more information from clients, store that information for future use, and use them to answer questions with an in-depth response. Finally, a new step to post-process the initial AI response, including proofreading, re-analyzing and re-generating for a better response.

The enhanced coach, according to various exemplary embodiments, may improve the financial advisor's time servicing the client. The enhanced coach can provide the same capabilities to the human advisor interacting with the client so that the human advisor can pull in relevant information from many sources to provide fiduciary, empathetic, professional, well-formed with relevant tools such as calculators built-in. e.g., could include a search-like function for the advisor to pull in appropriate content or even formulate an auto-generated plan in response to questions like “Client has had a life event (e.g., marriage or divorce). What steps should I suggest to the client?” Or “<This client> is going through a divorce. What should I suggest as the next steps to him?” This information will be secure, fiduciary, localized in terms of applicable laws, languages, etc.

1. An artificially intelligent system for financial coaching comprising:
a processor configured to execute instructions stored in memory to:
implement a privacy-preserving architecture that detects personally identifiable information using multi-layered pattern recognition comprising regular expressions for formatted data sequences, named entity recognition with confidence thresholds above 0.85, and contextual analysis algorithms, and strips detected PH while preserving financial semantic relationships through anonymization tokens;
execute a multi-step artificial intelligence processing pipeline comprising: automated detection of user query language and emotional tone classification using predetermined linguistic markers with confidence scoring, transformation of user financial profile data into descriptive natural language format for contextual processing, context-aware question rephrasing that incorporates historical interaction patterns and anonymized financial profile data, semantic similarity scoring using vector embeddings with financial domain vocabulary weighting applying multiplier values between 1.3-2.0 to predetermined financial terms and dynamically adjusted cosine similarity thresholds between 0.6-0.9, construction of meta-prompts that combine user context, retrieved content, and fiduciary instruction sets for large language model processing; and implement mood-based escalation logic that automatically escalates to human financial advisors when user emotional state indicators exceed predetermined confidence thresholds based on analysis of current and historical interaction tone patterns.

2. The system of claim 1, wherein the emotional tone classification identifies user mood states selected from the group consisting of: angry, frustrated, concerned, optimistic, positive, negative, and neutral, each assigned confidence scores between 0.0 and 1.0.

3. The system of claim 1, wherein the mood-based escalation logic triggers human advisor escalation when either: the current message tone is classified as angry or frustrated using confidence scores above 0.8, or two out of four previous interactions were classified as angry or frustrated with confidence scores above 0.7.

4. The system of claim 1, wherein the transformation of user financial profile data comprises converting numerical financial account data, demographic information, and goal parameters into grammatically correct descriptive sentences in natural language format using predefined templates for financial data categories.

5. The system of claim 1, wherein the context-aware question rephrasing incorporates user demographic data, financial account balances, established financial goals, and historical spending patterns to create personalized standalone questions using template-based sentence construction algorithms.

6. The system of claim 1, wherein the curated financial content comprises proprietary financial planning best practices, educational academy content, advisor knowledge bases, and anonymized financial planning consultation notes organized into searchable content segments of 100-500 words each.

7. The system of claim 1, wherein the semantic similarity scoring utilizes vector embedding techniques with financial domain vocabulary weighting that applies multiplier values between 1.3-2.0 to predetermined financial terms, and calculates cosine similarity scores with dynamically adjusted thresholds between 0.6-0.9 based on query specificity.

8. The system of claim 1, wherein the meta-prompt construction includes predefined fiduciary instruction parameters that constrain large language model responses to use conditional language constructs including “suggest,” “consider,” and “may want to” rather than imperative constructs including “should,” “must,” and “recommend.”

9. A method for privacy-preserving artificial intelligence financial coaching comprising:
receiving a financial query from a user through a conversational interface; automatically detecting personally identifiable information within the financial query using pattern recognition algorithms comprising regular expressions for Social Security numbers, phone numbers, and account number sequences, named entity recognition for person and organization names with confidence thresholds above 0.85, and contextual analysis of surrounding financial terms;
stripping the detected personally identifiable information while maintaining financial context data in local system memory through anonymization token replacement;
executing a sequential artificial intelligence processing workflow comprising:
analyzing the query to determine language type and emotional tone using natural language processing with confidence scoring, accessing user financial profile data stored locally and transforming said data into descriptive natural language format using predefined financial data templates, rephrasing the original query using the transformed financial profile data and historical interaction context to create a standalone question, performing semantic similarity matching between the rephrased query and a curated financial knowledge corpus using vector embeddings with financial domain vocabulary weighting, constructing a meta-prompt that combines the rephrased query, matched content, and predefined fiduciary instruction parameters; transmitting the meta-prompt with anonymized data to an external large language model for response generation; and
processing the generated response to include relevant educational content links before presentation to the user.

10. The method of claim 9, wherein detecting personally identifiable information comprises applying regular expression patterns including (\d{3}-\d{2}-\d{4}|\d{9}) for Social Security numbers, (\d{3}[-.]?\d{3}[-.]?\d{4}) for phone numbers, and sequences of 8-17 digits for financial account numbers.

11. The method of claim 9, wherein the sequential artificial intelligence processing workflow processes user queries in real-time with response generation completed within 3-8 seconds to maintain interactive conversation flow.

12. The method of claim 9, further comprising automatically adjusting response complexity and financial terminology based on detected user financial expertise levels determined through vocabulary analysis and question sophistication scoring.

13. The method of claim 9, wherein the semantic similarity matching ranks content segments using cosine similarity scores, applies financial domain vocabulary weighting with multiplier values between 1.3-2.0, and selects the top 3-10 highest-scoring segments based on query complexity for meta-prompt inclusion.

14. The method of claim 9, further comprising providing location-sensitive and date-sensitive financial guidance based on user geographic location and current date parameters, where location determines applicable tax regulations and date determines current contribution limits and regulatory requirements.

15. A computer-implemented artificial intelligence training system for financial advisory applications comprising:
a processor configured to expand training datasets by applying mathematical transformation functions to acquired financial data sets, wherein the mathematical transformation functions comprise calculating statistical standard deviations within the financial data sets and applying incremental variations between 0.5-2.0 times the standard deviations to generate additional training data points; a machine learning module configured to train an artificial intelligence network using the expanded training dataset through stochastic learning with backpropagation algorithms that calculate gradients of financial wellness prediction loss functions;
a false positive detection system configured to identify misclassified outputs during training iterations using accuracy threshold comparisons; an iterative refinement module configured to retrain the artificial intelligence network with updated training sets that incorporate the identified false positives to minimize classification errors through successive training cycles; and
a validation system configured to measure convergence between predicted financial wellness scores and actual wellness scores until the difference approaches zero or falls below a predetermined error threshold.

16. The training system of claim 15, wherein the statistical standard deviations are applied as incremental multipliers between 0.5-2.0 to create synthetic financial data points that maintain distribution characteristics within two standard deviations of original dataset means.

17. The training system of claim 15, wherein the stochastic learning with backpropagation comprises calculating gradients of loss functions based on differences between predicted and actual financial wellness scores with respect to network weights and updating weights using gradient descent optimization with learning rates between 0.001-0.1.

18. The training system of claim 15, wherein the iterative refinement module performs multiple training cycles until classification accuracy exceeds 95% for financial wellness score predictions or completes a maximum of 1000 training iterations.

19. The training system of claim 15, wherein the validation system measures convergence by comparing predicted financial wellness scores against actual user wellness scores tracked over a seven-year period using mean squared error calculations.

20. The training system of claim 15, further comprising a horizontal scaling architecture that increases processing capacity linearly with user load by adding computational nodes in increments of 10-100 concurrent users to maintain response times below 5 seconds regardless of total concurrent user numbers.
